(19) United States
(12) Patent Application Publication
(10) Pub. No.: US 2024/0015145 A1
(43) Pub. Date: Jan. 11, 2024

(54) PLATFORM FOR INFORMATION TECHNOLOGY MANAGEMENT AS A SERVICE

(71) Applicant: Microsoft Technology Licensing, LLC, Redmond, WA (US)

(72) Inventors: Yevgeniya ROSS, Paris (FR); Prasanna Chromepet PADMANABHAN, Redmond, WA (US); Derek Xianyang LIU, Issaquah, WA (US); Zachary Cole WILLSON, Redmond, WA (US); Amar Dinesh ZAVERY, Kirkland, WA (US); Somesh GOEL, Newcastle, WA (US)

(21) Appl. No.: 17/820,617

(22) Filed: Aug. 18, 2022

Related U.S. Application Data
(60) Provisional application No. 63/359,619, filed on Jul. 8, 2022.

(51) Int. Cl. H04L 9/40; H04L 41/0803

(52) U.S. Cl. CPC H04L 63/0823; H04L 63/18; H04L 41/0803

(57) ABSTRACT

A platform is configured to perform information technology management as a service. An instance of a servicing application is generated in a computing environment for a client entity identifier, such as a tenancy in a cloud platform of a host provider. The servicing application is created, and instantiated, with no pre-authorized permissions within the computing system, or with fewer pre-authorized permissions than another application in the computing system. A certificate of the servicing application is retrieved from a first data structure in a secure storage device of the computing system, an application authentication token is received from an identity service associated with the computing system based on the certificate, and IT management operations are performed in the computing environment by the servicing application instance based on the application authentication token providing authorization for the instance of the servicing application.

### CROSS REFERENCE TO RELATED APPLICATIONS

This application claims priority to U.S. Provisional Application No. 63/359,619, filed on Jul. 8, 2022, entitled “PLATFORM FOR INFORMATION TECHNOLOGY MANAGEMENT AS A SERVICE,” which is incorporated by reference herein in its entirety.

### BACKGROUND

External party access to electronic domains for management thereof can create security issues. Conventional solutions utilize the generation of user or administrator accounts for electronic domains to allow external parties to access resources of the electronic domains.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums are described herein for platforms configured to perform information technology management as a service. An instance of a servicing application is generated in a computing environment for a client entity identifier, such as a tenancy in a cloud platform of a host provider. The servicing application is created, and instantiated, with no pre-authorized permissions within the computing system, or with fewer pre-authorized permissions than at least one other application in the computing system. A certificate of the servicing application is retrieved from a first data structure in a secure storage device of the computing system, an application authentication token is received from an identity service associated with the computing system based on the certificate, and IT management operations are performed in the computing environment by the servicing application instance based on the application authentication token providing authorization for the instance of the servicing application.

Further features and advantages, as well as the structure and operation of various example aspects, are described in detail below with reference to the accompanying drawings. It is noted that the example implementations are not limited to the specific aspects described herein. Such example aspects are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example aspects of the present application and, together with the description, further serve to explain the principles of the example aspects and to enable a person skilled in the pertinent art to make and use the example aspects.

FIG. 1 shows a block diagram of an example network-based computing system configured as a platform for information technology management as a service, in accordance with an example aspect.

FIG. 2 shows a flowchart of a method in a platform for information technology management as a service, in accordance with an example aspect.

FIG. 3 depicts a system flow diagram illustrating a sequence of actions performed in a platform for information technology management as a service, in accordance with an example aspect.

FIGS. 4A and 4B depict two related portions of a flow diagram illustrating a sequence of actions performed in a platform for information technology management as a service, in accordance with an example aspect.

FIG. 5 shows a flowchart of a method in a platform for information technology management as a service, in accordance with an example aspect.

FIG. 6 is a block diagram of an example mobile device that are used to implement various aspects.

FIG. 7 is a block diagram of an example processor-based computer system that are used to implement various aspects.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations.

Numerous examples are described as follows. It is noted that any section/subsection headings provided herein are not intended to be limiting. Implementations are described throughout this document, and any type of implementation can be included under any section/subsection. Furthermore, implementations disclosed in any section/subsection can be combined with any other implementations described in the same section/subsection and/or a different section/subsection in any manner.

### II. Example Implementations

Aspects described herein are directed to platforms for information technology (IT) management as a service. For example, managed services include, without limitation, IT management as a service in which customers, tenants, users, etc., (generally “client entities” hereinafter) have their domains managed by a host provider that performs the IT management as a service. Domains generally herein refer to, without limitation, tenancies, logical domains in a network, and/or the like (generally a “computing environment” hereinafter).

Aspects herein provide for a specifically configured servicing application of which an instance is deployed in the client entity domain by the host provider. In one illustrative, non-limiting example, a client entity is a tenant with a tenancy in a cloud-based platform such as Amazon Web Services® of Amazon Web Services, Inc. or Google Cloud Platform™ of Google LLC. In order to provide this IT management as a service, aspects herein enable changes to be made to one or more client entities in a controlled and protected manner to keep client entity devices up-to-date and ensure productivity and security.

Aspects provide an extensible platform and techniques to manage changes and change types in tenancies such as Intune® estates and analogous environments through validation of management payload content against the current tenant state (e.g., the desired state system) as well as service level objectives (SLOs), e.g., MMD-defined SLOs, to maintain productive environments that are free from device issues like application crashes, battery drain, access policy issues, etc. The aspects herein utilize an Application-Only Authorization that enables more secure management of client entities by a host provider, e.g., over existing user/administrator accounts, at any scale. That is, the described platforms and techniques herein for IT management as a service overcome the technical issues of accessing a secure computing environment by providing a safe way to deploy policy, script, and/or application changes, updates, configuration modifications, etc., across thousands of client entities and millions of devices.

Existing solutions utilize user or administrator accounts that are generated for each electronic domain to be managed for a client entity. To allow parties that are external to the client entity, e.g., a host provider, to access resources of these domains, the accounts require manual maintenance and frequent synchronizations, require external parties to have the accounts within the domains potentially decreasing security, and can also lead to authentication conflicts between the accounts and the electronic domain access policies. Additionally, existing applications of host providers that are generated with pre-authorized permissions for performance of operations in a client entity computing environment are not well suited for IT management as a service at least because such pre-authorized permissions potentially expose a very large number of client entity devices if compromised.

Accordingly, the aspects herein provide for technical solutions to issues associated with maintenance and service continuity and security. These and other aspects in platforms for IT management as a service will be described in further detail herein in association with the Figures, and in the Sections/Subsections of description that follow below.

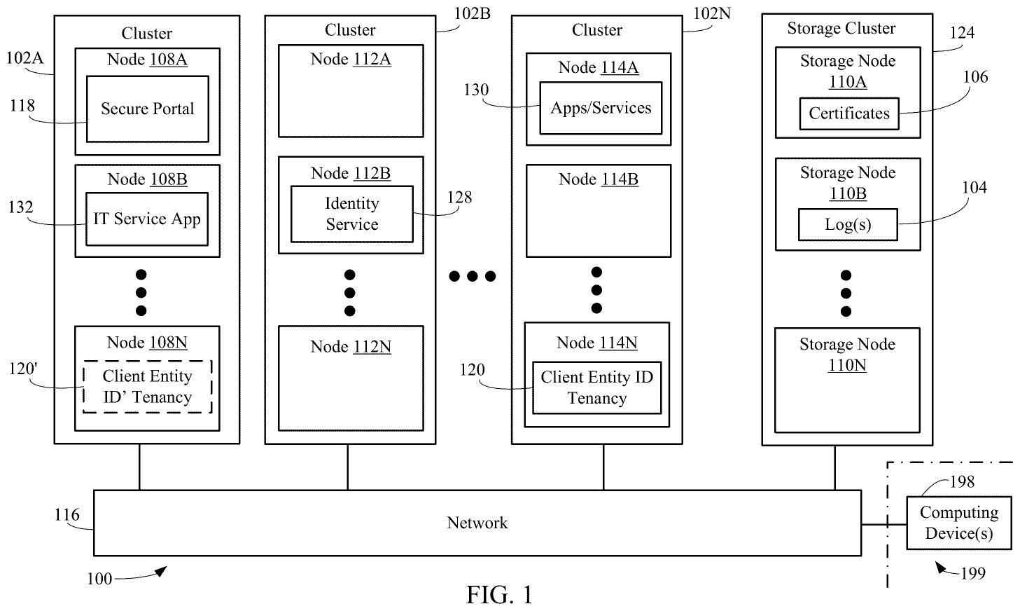

For example, FIG. 1 shows a block diagram of an example network-based computing system 100 configured for platforms for IT management as a service, according to an example aspect. As shown in FIG. 1, system 100 includes a plurality of clusters 102A, 102B, and 102N and a storage cluster 124. Each of clusters 102A, 102B, and 102N, and storage cluster 124, are communicatively coupled to each other via network 116. Network 116 comprises one or more networks such as, but without limitation, a cloud network, a local area networks (LANs), wide area networks (WANs), enterprise networks, the Internet, etc., and includes, without limitation, one or more of wired and/or wireless portions.

Clusters 102A, 102B and 102N and/or storage cluster 124 form a network-accessible server set (e.g., a distributed or cloud-based environment or services platform (e.g., an environment/platform hosting types of resources, services, and/or applications)). Each of clusters 102A, 102B and 102N comprises a group of one or more nodes (also referred to as compute nodes) and/or a group of one or more storage nodes. For example, as shown in FIG. 1, cluster 102A includes nodes 108A-108N, cluster 102B includes nodes 112A-112N, and cluster 102N includes nodes 114A-114N. Each of nodes 108A-108N, nodes 112A-112N, and/or nodes 114A-114N are accessible via network 116 (e.g., in a “cloud-based” aspect) to build, deploy, and manage applications and services and tenancies. Storage cluster 124 comprises one or more storage nodes 110A-110N. Each of storage node(s) 110A-110N comprises a plurality of physical storage disks, that are configured as secure storage, and that are accessible via network 116 and are configured to store data associated with the applications and services managed by nodes 108A-108N, nodes 112A-112N, and/or nodes 114A-114N.

As noted above, in aspects, system 100 includes one or more distributed or “cloud-based” servers. That is, system 100 is a network, or “cloud,” implementation for applications and/or services, which is associated with hosting databases, data warehousing, websites including web stores, productivity applications, analytics, and/or the like, in a network architecture/cloud platform, in aspects. A cloud platform includes a networked set of computing resources, including servers, routers, etc., that are configurable, shareable, provide data security, and are accessible over a network such as the Internet, according to aspects. The cloud applications/services are configured to run on these computing resources, often atop operating systems that run on the resources, for entities that access the applications/services, locally and/or over the network.

A cloud platform is configured to support multi-tenancy as noted herein, where cloud platform-based software services multiple tenants, with each tenant including one or more users who share common access to certain software services and applications of the cloud platform, as noted herein. Furthermore, a cloud platform is configured to support hypervisors implemented as hardware, software, and/or firmware that run virtual machines (emulated computer systems, including operating systems) for tenants. A hypervisor presents a virtual operating platform for tenants in the cloud platform, and a tenancy (or a computing environment of a client entity, generally), comprises a portion of one or more virtual machines.

In an aspect, one or more of cluster 102A, cluster 102B, and cluster 102N, and/or storage cluster 124, are be co-located (e.g., housed in one or more nearby buildings with associated components such as backup power supplies, redundant data communications, environmental controls, etc.) to form various computing platforms, or are arranged in other manners. Accordingly, in an aspect, one or more of cluster 102A, cluster 102B, and cluster 102N, and/or storage cluster 124, are a computing platform/system in a distributed collection of computing platforms/systems.

Each of node(s) 108A-108N, node(s) 112A-112N, and node(s) 114A-114N comprise one or more server computers, server systems, and/or computing devices, in aspects. Each of node(s) 108A-108N, node(s) 112A-112N, and node(s) 114A-114N are configured to execute one or more software applications (or “applications”) and/or services and/or manage hardware resources (e.g., processors, memory, network adapters, etc.), which are utilized by users or client entities (e.g., customers or tenants in cloud-based platforms) of the network-accessible server set. Node(s) 108A-108N, node(s) 112A-112N, and node(s) 114A-114N are also configured for specific uses. For example, in aspects and as shown in FIG. 1, node 108A, is configured to execute a secure portal 118, node 108B node is configured to execute an IT servicing application 132 (servicing application 132), node 112B is configured to execute an identity service 128, node 114A is configured to execute other applications and/or services 130, and node 114N is configured to execute client entity identifier tenancy 120 (tenancy 120). It is noted that instances of servicing application 132, identity service 128, other applications and/or services 130, and/or tenancy 120 are executing on other node(s) (e.g., node(s) 108B-108N, node(s) 112A-112N, and/or node(s) 114A-114N) in lieu of or in addition to the nodes respectively noted above. It is further noted that one or more of these components are incorporated with each other, in various aspects.

Identity service 128, in aspects, is configured to maintain a plurality of user identities by which associated users utilize to access one or more tenancies, devices, applications, and/or services maintained by system 100 (e.g., tenancies, web application, and/or services hosted and/or executed by any of node(s) 108A-108N, node(s) 112A-112N, and/or node(s) 114A-114N) and/or associated with identity service 128. Likewise, identity service 128 is, in aspects, configured to maintain a plurality of workload identities and associated credentials, which are used for authentication and access by service principals (e.g., instances of applications executing in a tenancy). In response to a successful validation, such as by trusted certificate, the instance is provided access to the tenancy, device, application, and/or service, as described herein.

Other applications and/or services 130 includes, without limitation, one or more applications, services, etc., that are hosted by system 100, and that have instances thereof executed by a tenancy, such as tenancy 120. Non-limiting examples of other applications and/or services 130 include, without limitation, productivity applications, policy enforcement applications, analytics services, database/data warehousing services/applications, web hosting applications/services including for web stores, etc. In some aspects, other applications and/or services 130 include applications and/or services such as those offered to tenants of various subscriptions as hosted by the cloud platform providers mentioned herein or otherwise known.

Tenancy 120 is configured as a portion of one or more virtual machines, as described herein, that comprise a computing environment for a client entity (e.g., a tenant) and that is associated with an identifier (ID) of the client entity, e.g., a client entity ID. One or more of servicing application 132 and/or other applications and/or services 130 have instances thereof (e.g., service principals) executing within, or executed by, tenancy 120 based on its configuration and subscriptions to system 100 and the host provider. A tenancy 120′ (120 “prime”) illustrates another, different client entity that is associated with another entity ID (“ID′” (ID “prime”)) to illustrate that two or more computing environments are contemplated herein for aspects of IT management as a service. Aspects described herein that refer to tenancy 120, or computing environments generally, are also contemplated as being applicable to tenancy 120′, as well as to additional computing environments not shown for the sake of brevity and illustrative clarity.

Secure portal 118 is a secure portal by which members of the host provider associated with system 100, e.g., IT service engineers, are enabled via restricted access to add, manage, update, implement, etc., applications and/or services hosted by system 100.

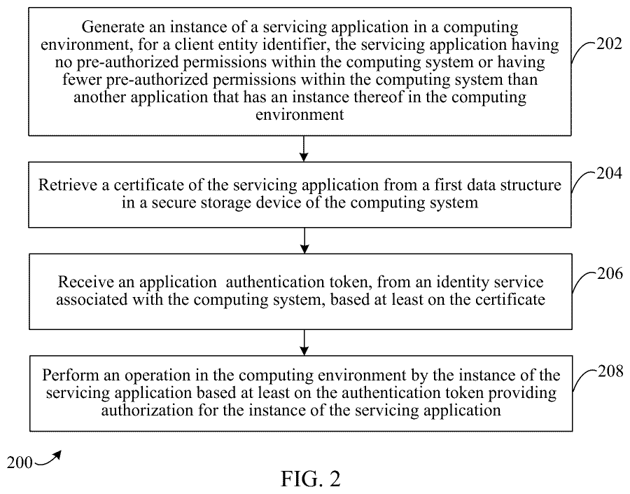

Servicing application 132 is configured to perform, via the platform of system 100 in the illustrated aspect, IT management as a service. The IT management as a service performed by servicing application 132 are provided for client entities, e.g., via tenancies of tenants hosted by system 100, such as tenancy 120, via instances of servicing application 132 that are executed by the tenancies in the computing environments thereof. In some aspects, servicing application 132 is deployed via secure portal 118 to identity service 128 from which servicing application 132 is invoked by application registrations for the platform illustrated by system 100 in FIG. 1. Further details regarding the operations and configuration of servicing application 132 are provided below with respect to FIGS. 2, 3, 4A, 4B, and 5.

Log files 104 are stored in a storage node, in aspects, as exemplarily shown for storage node 110B, or elsewhere in different aspects. Log files 104 include device telemetry, metrics, and/or the like that are collected subsequent to a validation of a payload for servicing application 132, as noted herein. Certificates 106 are stored in a storage node, as exemplarily shown for storage node 110A, or elsewhere in different aspects, and storage node 110A comprise a secure storage such as an encrypted database structure, a key vault, and/or the like. One of certificates 106 is associated with servicing application 132 and enable servicing application 132 to receive an authorization token from identity service 128 in order to perform operations in the computing environment of tenancy 120. At least one of certificates 106 is generated by an IT service engineer and stored thereby in storage node 110A via secure portal 118.

In aspects, operations for IT as a service include, without limitation, altering of a configuration setting for at least one device associated with the computing environment, installing a software update associated with an instance of an application in the computing environment, creating or modifying a group in a directory for the computing environment, altering an access policy for the computing environment, and/or the like.

Also shown in FIG. 1 is an external environment 199 in which one more computing devices 198 that are external to system 100 connect to system 100, e.g., via the Internet and network 116. One or more computing devices 198 includes any number of computing and/or mobile devices/systems utilized by client entities and members of the host provider associated with system 100. One or more computing devices 198 in various aspects includes any number, type, or combination of other computing devices and/or computing systems, including but without limitation, a terminal, a personal computer, a laptop computer, a tablet device, a smart phone, a personal digital assistant, a server(s), a gaming console, and/or the like, that include internal/external storage devices, that are utilized to access tenancies, services, and/or applications, and/or to otherwise upload and/or download any type of information, data, files, programs, and/or the like, to/from system 100. In some aspects, a device of one or more computing devices 198 are utilized by an IT service engineer, while another of one or more computing devices 198 is utilized by an administrator of a client entity, while still others of one or more computing devices 198 are devices utilized by members of tenancy 120 (which are managed by servicing application 132), as described herein.

Referring now to FIG. 2, a flowchart 200 is shown for a method in a platform for IT management as a service, in accordance with an example aspect. In various aspects, flowchart 200 is implemented by system 100 shown in FIG. 1, although the method is not limited to that implementation. Accordingly, flowchart 200 will be exemplarily described with continued reference to FIG. 1. Other structural and operational aspects will be apparent to persons skilled in the relevant art(s) based on the discussion regarding flowchart 200 and system 100 of FIG. 1.

Flowchart 200 begins with step 202. In step 202, an instance of a servicing application is generated in a computing environment, for a client entity identifier, the servicing application having no pre-authorized permissions within the computing system or having fewer pre-authorized permissions within the computing system than another application that has an instance thereof in the computing environment. For example, servicing application 132 in FIG. 1 is generated by an IT service engineer(s) and deployed via secure portal 118 and a certificate for servicing application 132 is generated and stored in storage node 110A. Servicing application 132 is generated with no pre-authorized permissions or with fewer pre-authorized permissions than other applications having instances executed by a computing environment. That is, servicing application 132 is utilized to perform IT management as a service in a computing environment associated with a client entity ID, during which servicing application 132 is enabled to make changes, updates, configuration modifications, etc., and thus the pre-authorized permissions for servicing application 132 are excluded and/or restricted when generated and deployed to prevent exposure of any client entity computing environments and/or devices if servicing application 132 is somehow compromised.

Rather than granting pre-authorized permissions for servicing application 132 to perform IT management as a service, which poses security risks, the example platforms herein, e.g., system 100 in FIG. 1, provide alternate mechanisms for authentication of servicing application 132 to perform its operations for IT management as a service.

Creating the instance of servicing application 132 to be executed in the computing environment such as a tenancy, e.g., by a virtual machine thereof, is predicated in some aspects by an administrator of the client entity enrolling in IT management as a service with host provider via servicing application 132, a client portal, tenancy 120, and/or the like. This enrollment is reflected in identity service 128 for the client entity ID of the computing environment by writing indicia of enrollment, as corresponding data, to a data structure of identity service 128. Subsequent to enrollment, an instance (e.g., a service principal) of servicing application 132 is instantiated and executed in the computing environment to perform IT management operations. In aspects, the instance is created by servicing application 132 based on action needed in the computing environment via a payload to be deployed by servicing application 132, and is created with a minimal number of application permissions needed to perform IT management as a service as a security consideration.

In step 204, a certificate of the servicing application is retrieved from a first data structure in a secure storage device of the computing system. For instance, the certificate of certificates 106 that is associated with servicing application 132 is retrieved from the secure storage of storage node 110A by servicing application 132, in aspects.

In step 206, an application authentication token is received, from an identity service associated with the computing system, based at least on the certificate. For example, servicing application 132 provides the certificate retrieved from storage node 110A in step 204 to identity service 128. Identity service 128 is configured to validate the certificate as being from a trusted source and associated with servicing application 132, and in response to the validation, identity service 128 issues an authorization token associated with the computing environment, e.g., tenancy 120, to servicing application 132 enabling servicing application 132 to access and perform operations in tenancy 120.

In step 208, an operation is performed in the computing environment by the instance of the servicing application based at least on the application authentication token providing authorization for the instance of the servicing application. For instance, servicing application 132 is configured to provide the authorization token, received in step 206 from identity service 128, to the instance of servicing application 132, e.g., the service principal executing in tenancy 120, enabling the instance to perform operations for IT management as a service.

In some aspects, operations for IT management as a service that are performed by the service principal/instance of servicing application 132 are carried out via scripts, applications derived/generated from patches and/or updates, policy change information, etc. Operations include, without limitation, an alteration of a configuration setting for at least one device associated with the computing environment, installing a software update associated with an instance of an application in the computing environment, creating or modifying a group in a directory for the computing environment, an alteration of an access policy for the computing environment, and/or the like, and it is contemplated herein that other operations for IT management are performed, as would be recognized by persons of skill in the relevant art(s) having the benefit of this disclosure.

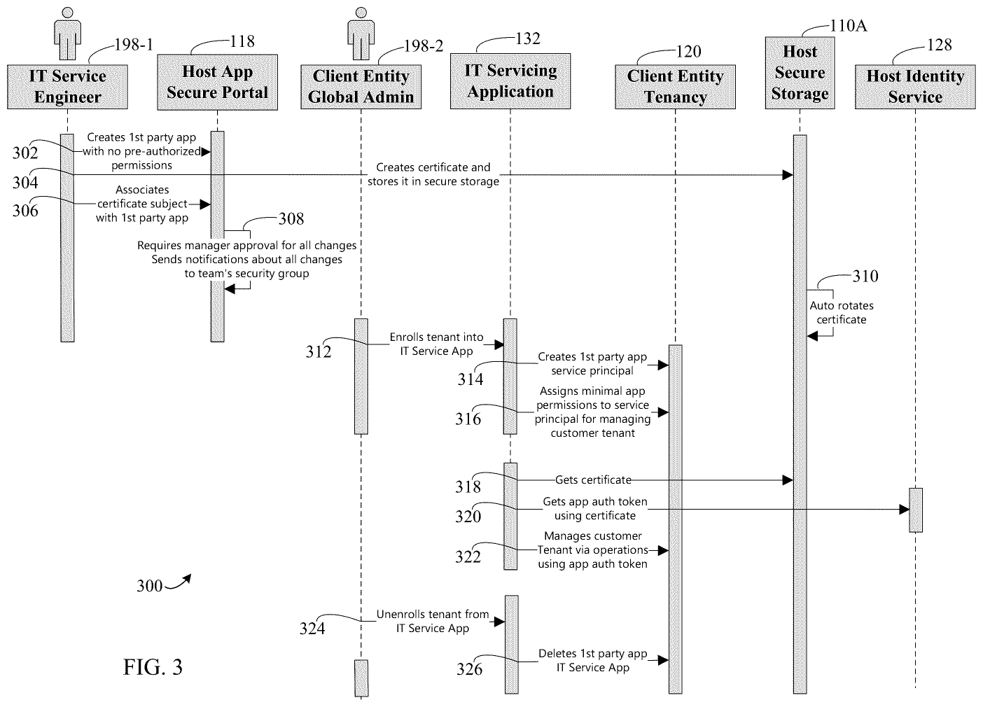

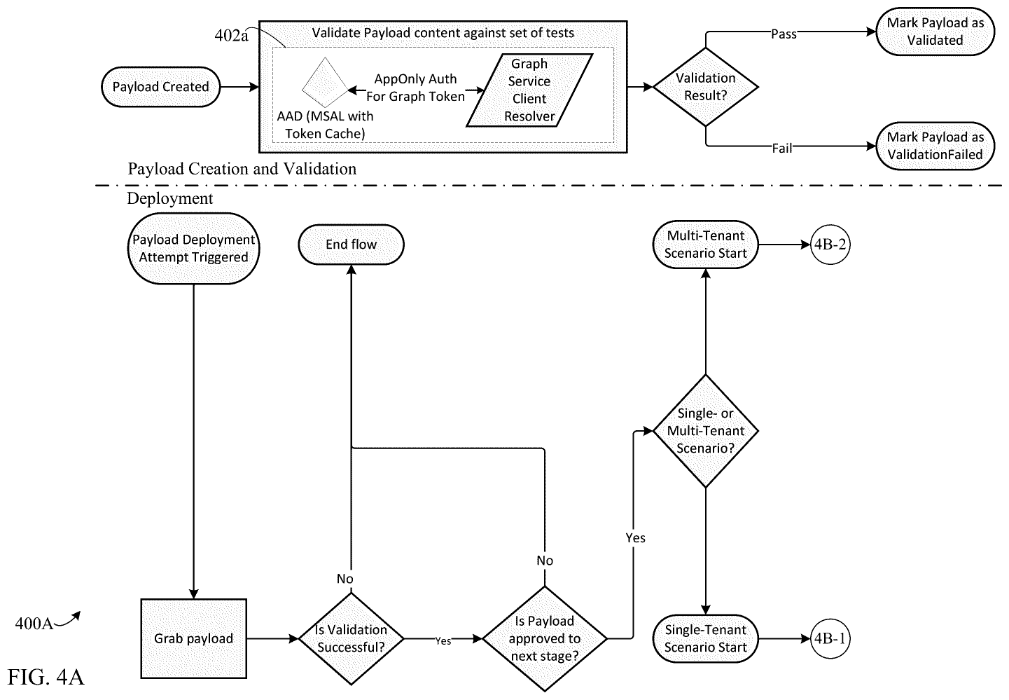

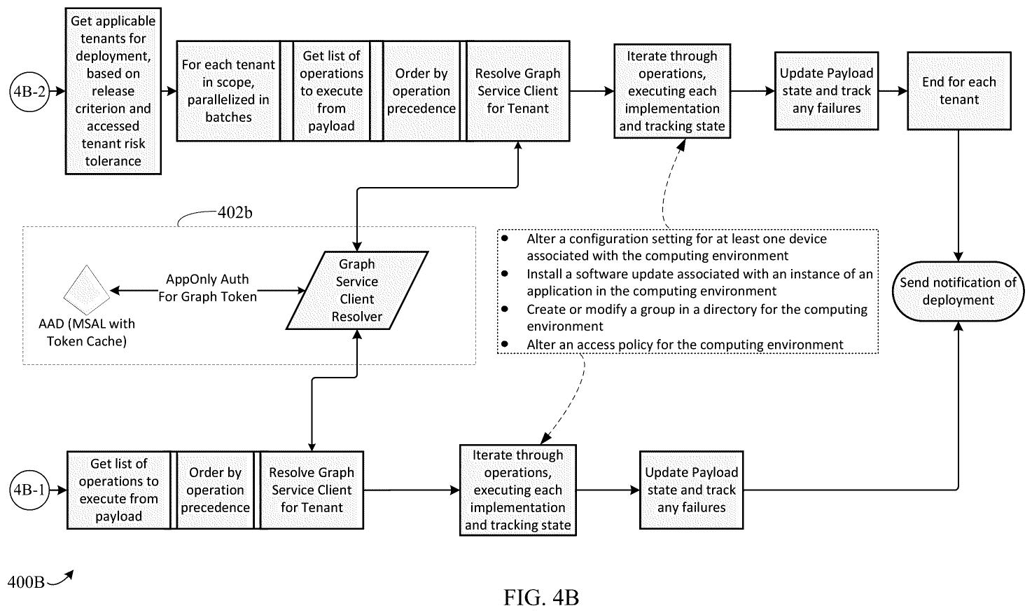

Further details regarding platforms for IT management as a service and flowchart 200 are provided below in reference to the described Figures. For example, FIGS. 3, 4A, and 4B will now be described in this context.

FIG. 3 depicts a system flow diagram 300 illustrating a sequence of actions performed with respect to a platform for IT management as a service, in accordance with an example aspect. System flow diagram 300 is based on a system 100 and external environment 199 of FIG. 1. Other structural and operational aspects will be apparent to persons skilled in the relevant art(s) based on the discussion regarding system 100 and external environment 199 of FIG. 1 and system flow diagram 300.

As shown, system flow diagram 300 exemplarily illustrates components from system 100 in FIG. 1: secure portal 118, servicing application 132, tenancy 120, secure storage of storage node 110A, and identity service 128; as well exemplarily illustrating a client device 198-1 of an IT service engineer and a client device 198-2 of an administrator of a client entity (e.g., having an ID associated with tenancy 120) that are aspects of one or more computing devices 198 in external environment 199 of FIG. 1.

System flow diagram 300 illustrates cloud platform-based operations for IT management as a service that utilizes Application-Only Authorization for a servicing application to securely perform IT management in a computing environment associated with a client entity ID instead of via a user/administrator account of a party that is outside of the client entity. That is, instances of an application such as servicing application 132, e.g., service principals, are excluded from conditional access policies in computing environments herein. The conditional access policies of computing environments apply to all users, but not to service principals. Service principals are more trusted in the described aspects because they are not utilized by typical users to log in to the computing environment-instead, service principals are utilized as services for systems as first-party applications, i.e., applications of the system itself rather than third-party applications, which perform operations/functions in a more secure manner that excludes user interference and bad actors.

First-party applications generally receive pre-authorized permission to perform their associated operations and functions, however, servicing application 132 is generated/created (302) and deployed via secure portal 132 by an IT service engineer utilizing client device 198-1 with no pre-authorized permission, or at least with fewer pre-authorized permission that other first-party applications, e.g., applications of the host provider that executing in system 100. As noted herein, this improves overall system security and security for accesses to computing environments such as tenancies. In this manner, an instance or service principal of servicing application 132 in tenancy 120 cannot by itself perform any operations as initially deployed.

To enable access and permissions for servicing application 132, a certificate is created (304) via client device 198-1 and stored via secure portal 118 in storage node 110A as one of certificates 106. The certificate subject is associated (306) with servicing application 132 to provide a link of trust therebetween. For instance, when the application authentication token is to be obtained, servicing application 132 presents the certificate to identity service 128 to obtain the token. In some aspects, when servicing application 132 is generated and deployed, e.g., to node 108B in FIG. 1, servicing application 132 as well as the certificate are protected from attackers or from being stolen by only permitting creation/deployment and changes/alterations to be made from secure access workstations such as client device 198-1. Additionally, secondary approvals (308) for any changes and notifications are required to further increase security, and specific alternate credentials, just-in-time access, etc., for secure portal 118 and/or client device 198-1 are also required, in aspects.

When a client entity that is identified in association with a computing environment, such as an administrator of tenancy 120, enrolls (312) for IT management as a service with servicing application 132 via client device 198-2, an instance or service principal of servicing application 132 is created (314) for the computing environment through servicing application 132, e.g., in tenancy 120. The instance or service principal is assigned (316) the minimal application permissions need for performing IT management as a service within the computing environment, tenant 120. Aspects herein provide for storing the assigned minimal application permissions for the servicing application/instance in a data structure of a memory/storage in the hosting system that is associated with the computing environment. In this way, and because pre-authorized permissions are not associated with servicing application 132 itself, the permissions now granted to the instance/service principal are limited to the computing environment (e.g., tenancy 120) enrolled and are not applicable to other un-enrolled tenancies in system 100, thus exposure of other computing environments and client devices associated therewith is limited or removed entirely if servicing application 132 is compromised.

Execution of the instance/service principal for servicing application 132 to perform IT management as a service is performed in the background of the computing environment and includes retrieving (318) the associated certificate from certificates 106 securely stored in storage node 110A, and then utilizing the certificate and information associated with the client entity ID for the computing environment, e.g., tenancy 120, to receive (320) an application authentication token from identity service 128. The provision of the application authentication token from identity service 128 is predicated on validation of the certificate for the computing environment to ensure that consent for enrollment was given and access is authorized.

In some aspects, as a background process, the certificate stored in certificates 106 that is associated with servicing application 132 is auto-rotated (310) according to policies of system 100, which require the certificate to be auto-rotated, in aspects, based on a pre-defined time period, e.g., every 90 days or other amount of time, as mitigation against the certificate being stolen or otherwise compromised. Additionally, the application authentication token has a lifetime set to a pre-defined time period, e.g., 1 hour or some other time to perform operations herein for IT management as a service.

Utilizing the application authentication token for operational permissions, servicing application 132 is enabled to access the computing environment, e.g., tenancy 120, to perform (322) operations for IT management as a service, as described herein.

An administrator is enabled to unenroll (324) a computing environment from the IT management as a service provided herein. This is done, e.g., utilizing client device 198-2 via servicing application 132 and/or tenancy 120. When consent is removed for this unenrollment, servicing application 132 removes/deletes (326) its instance/service principal and the associated permissions in the computing environment, e.g., tenancy 120.

FIGS. 4A and 4B will now be described. The illustrative aspects in FIGS. 4A and 4B are exemplary in nature, and are not to be considered limiting. For example, orders of operation, values of parameters and numbers in the illustrated example, etc., are varied in other aspects and are provided for purposes of description generally for platforms for IT management as a service.

FIG. 4A shows a flow diagram 400A and FIG. 4B shows a flow diagram 400B with respect to a platform for IT management as a service, in accordance with an example aspect. In various aspects, flow diagram 400A and flow diagram 400B are two portions of a single flow diagram, formatted as shown for illustrative purposes and conformance. Flow diagram 400A and flow diagram 400B are implemented by system 100 and/or external environment 199 of FIG. 1, although the described functions and operations are not limited to that implementation, and is an aspect of step 208 in flowchart 200 of FIG. 2. Accordingly, flow diagram 400A and flow diagram 400B will be exemplarily described with continued reference to FIGS. 1 and 3. Other structural and operational aspects will be apparent to persons skilled in the relevant art(s) based on the discussion regarding system 100 and external environment 199 of FIG. 1, and system flow diagram 300, as well as flow diagram 400A and flow diagram 400B.

As noted herein, the platforms for IT management as a service enable management and maintenance of computing environments and devices associated therewith. In aspects, this includes the creation of objects within the computing environments. This is objects that are, or that represent, a software application (e.g., first- and/or third-party applications) to be deployed in a computing environment, software updates that need to be deployed, scripts such as PowerShell scripts to perform operations/functions in a computing environment or on the devices, policies to be deployed to keep a computing environment and/or its associated devices secure, and/or the like. The objects are generated or deployed as payloads via servicing application 132 to instances/service principals thereof. Such payloads are validated prior to deployment in various ways described herein.

The IT management as a service aspects herein are performed for single- or multi-computing environments, such as a single tenancy or at least two tenancies for a given operation. As noted above, Application-Only Authorization is utilized for servicing application 132 instances/service principals to perform an operation(s) in a computing environment(s) based on an application authorization token. This is illustrated as a region 402b in FIG. 4B. Aspects also provide for validation of payloads for the operation(s) which also includes utilization of Application-Only Authorization as shown for a region 402a in FIG. 4A. That is, information from tenancies and/or devices associated therewith on which an operation is performed is gathered in a log file of log files 104 stored in storage node 1101B of FIG. 1, as described above, in aspects. The information in the log file is used, in aspects, to determine not only whether the operation was completed, but also to determine of the operation had the desired or intended effect and/or that unintended effects are not present. In other words, the deployments of payloads have their actions mapped to their intended effects for validation thereof.

In one aspect, a payload is validated against a set of tests to determine if the operation(s) of the payload complete successfully without unintended effects to environments, devices, etc. The set of tests are performed in a sandbox or testing computing environment. In another aspect, in addition to (e.g., subsequent to) or in lieu of validating against the set of tests, a smaller subset of computing environments and/or associated computing devices (e.g., 10% or less of the total number) have the payload deployed, as described herein, for validation prior to deploying the payload to additional computing environments and/or associated computing devices. This process is repeated for larger and larger subsets of computing environments and/or associated computing devices as each increasing subset is validated. Validation failure ends the deployment, or further deployment, and a notification(s) of failure is optionally provided to an IT service engineer via, e.g., servicing application 132 and/or computing device 198-1 of FIG. 1.

In some aspects, deployment of a payload is performed after its validation, for single- and/or multi-computing environment scenarios. Further exemplary details of payload deployment are illustrated and described in flow diagram 4A and flow diagram 4B.

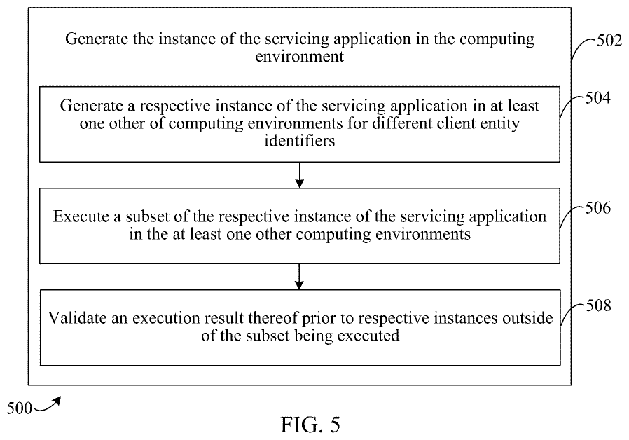

In furtherance of the payload validation described above, FIG. 5 will now be described. FIG. 5 shows a flowchart 500 of a method in a platform for information technology management as a service, according to an example aspect. In various aspects, flowchart 500 is implemented by system 100 shown in FIG. 1, although the method is not limited to that implementation. Accordingly, flowchart 500 will be exemplarily described with continued reference to FIG. 1. Other structural and operational aspects will be apparent to persons skilled in the relevant art(s) based on the discussion regarding flowchart 500 and system 100 of FIG. 1.

Flowchart 500 begins with step 502. In step 502, the instance of the servicing application is generated in the computing environment. Step 502 is a further aspect of step 202 of flowchart 200 in FIG. 2. In the described aspect, step 502 includes additional implementation details and/or operations over step 202.

In step 504, a respective instance of the servicing application is generated in at least one other of computing environments for different client entity identifiers. For instance, as noted above, e.g., regarding step 202, a computing environment for a client entity identifier has an instance of the servicing application generated therein, and in step 504, another instance(s) of the servicing application is generated in another computing environment(s) for another, different client entity identifier(s). As one example, another tenant's(s') computing environment(s) have their own instance of the servicing application generated therein.

In step, 506, a subset of the respective instance of the servicing application is/are executed in the at least one other computing environments. For instance, information from tenancies and/or devices associated therewith on which an IT as a service operation is performed are gathered in a log file (e.g., log files 104 stored in storage node 110B of FIG. 1), as described above. The information in the log file is used to determine not only whether the operation was completed, but also to determine of the operation had the desired or intended effect and/or that unintended effects are not present.

In step 508, in the context of step 506, an execution result thereof is validated prior to respective instances outside of the subset being executed. For instance, a payload is validated against a set of tests to determine if the operation(s) of the payload complete successfully without unintended effects to environments, devices, etc. The set of tests are performed in a sandbox or testing computing environment, in aspects. In another aspect, in addition to (e.g., subsequent to) or in lieu of validating against the set of tests, a smaller subset of computing environments and/or associated computing devices (e.g., 10% or less of the total number) have the payload deployed, as described herein, for validation prior to deploying the payload to additional computing environments and/or associated computing devices. This process is repeated for larger and larger subsets of computing environments and/or associated computing devices as each increasing subset is validated.

Accordingly, platforms for information technology management as a service are implemented in various ways in the aspects herein.

### III. Example Mobile and Computer System Implementations

Aspects described herein are variously implemented in hardware, or hardware combined with software and/or firmware. For example, aspects described herein are variously implemented as computer program code/instructions configured to be executed in one or more processors and stored in a computer readable storage medium. Alternatively, aspects described herein are variously implemented as hardware logic/electrical circuitry.

As noted herein, the aspects described, including but not limited to, system 100 in FIG. 1, along with any components and/or subcomponents thereof, as well any data structures, and operations and portions of flowcharts/flow diagrams described herein and/or further examples described herein, are implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), an application specific integrated circuit (ASIC), a trusted platform module (TPM), and/or the like. A SoC includes an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Aspects described herein are implemented in one or more computing devices similar to a mobile system and/or a computing device in stationary or mobile computer aspects, including one or more features of mobile systems and/or computing devices described herein, as well as alternative features. The descriptions of computing devices provided herein are provided for purposes of illustration, and are not intended to be limiting. Aspects are implemented in further types of computer systems, as would be known to persons skilled in the relevant art(s).

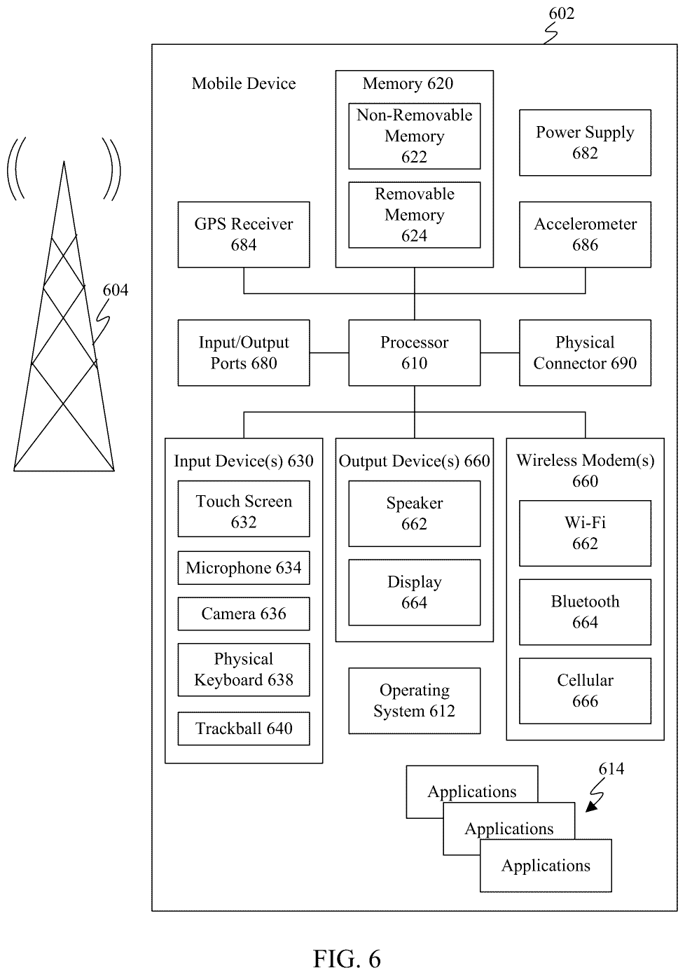

FIG. 6 shows a block diagram of an exemplary mobile device 600 including a variety of optional hardware and software components, shown generally as components 602. Any number and combination of the features/elements of components 602 are included in a mobile device aspect, as well as additional and/or alternative features/elements, as would be known to persons skilled in the relevant art(s). It is noted that any of components 602 can communicate with any other of components 602, although not all connections are shown, for ease of illustration. Mobile device 600 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 604, such as a cellular or satellite network, or with a local area or wide area network.

The illustrated mobile device 600 can include a controller or processor referred to as processor circuit 610 for performing such tasks as signal coding, image processing, data processing, input/output processing, power control, and/or other functions. Processor circuit 610 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 610 is configured to execute program code stored in a computer readable medium, such as program code of one or more applications 614, operating system 612, any program code stored in memory 620, etc. Operating system 612 can control the allocation and usage of the components 602 and support for one or more application programs 614 (a.k.a. applications, “apps”, etc.). Application programs 614 can include common mobile computing applications (e.g., email applications, calendars, contact managers, web browsers, messaging applications) and any other computing applications (e.g., word processing applications, mapping applications, media player applications).

As illustrated, mobile device 600 can include memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory or a Subscriber Identity Module (SIM) card, which is well known in GSM communication systems, or other well-known memory storage technologies, such as “smart cards.” The memory 620 can be used for storing data and/or code for running the operating system 612 and the applications 614. Example data can include web pages, text, images, sound files, video data, or other data sets to be sent to and/or received from one or more network servers or other devices via one or more wired or wireless networks. Memory 620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs are stored in memory 620. These programs include operating system 612, one or more application programs 614, and other program modules and program data. Examples of such application programs or program modules include, for example, computer program logic (e.g., computer program code or instructions) for implementing the systems described above, including the workflow development and execution systems described in reference to FIGS. 1-5.

Mobile device 600 can support one or more input devices 630, such as a touch screen 632, microphone 634, camera 636, physical keyboard 638 and/or trackball 640 and one or more output devices 650, such as a speaker 652 and a display 654.

Other possible output devices (not shown) can include piezoelectric or other haptic output devices. Some devices can serve more than one input/output function. For example, touch screen 632 and display 654 can be combined in a single input/output device. The input devices 630 can include a Natural User Interface (NUI).

Wireless modem(s) 660 can be coupled to antenna(s) (not shown) and can support two-way communications between processor circuit 610 and external devices, as is well understood in the art. The modem(s) 660 are shown generically and can include a cellular modem 666 for communicating with the mobile communication network 604 and/or other radio-based modems (e.g., Bluetooth 664 and/or Wi-Fi 662). Cellular modem 666 is configured to enable phone calls (and optionally transmit data) according to any suitable communication standard or technology, such as GSM, 3G, 4G, 5G, etc. At least one of the wireless modem(s) 660 is typically configured for communication with one or more cellular networks, such as a GSM network for data and voice communications within a single cellular network, between cellular networks, or between the mobile device and a public switched telephone network (PSTN).

Mobile device 600 can further include at least one input/output port 680, a power supply 682, a satellite navigation system receiver 684, such as a Global Positioning System (GPS) receiver, an accelerometer 686, and/or a physical connector 690, which can be a USB port, IEEE 1394 (FireWire) port, and/or RS-232 port. The illustrated components 602 are not required or all-inclusive, as any components can be not present and other components can be additionally present as would be recognized by one skilled in the art.

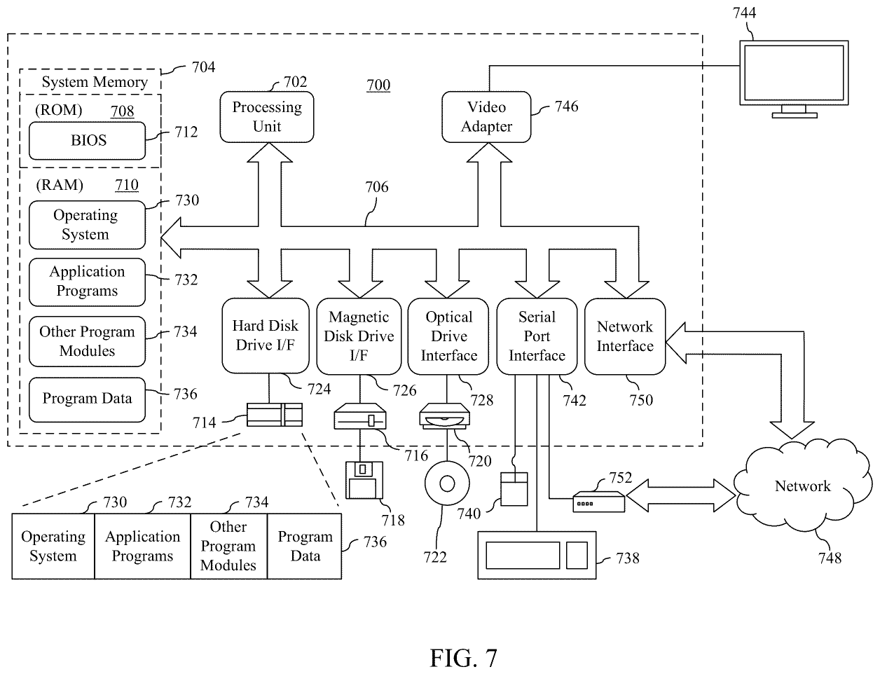

FIG. 7 depicts an exemplary implementation of a computing device 700 in which aspects are implemented, including system 100 of FIG. 1, along with any components and/or subcomponents thereof, as well as the data structures, flowcharts/flow diagrams, etc., described herein, including portions thereof, and/or further examples described herein. The description of computing device 700 provided herein is provided for purposes of illustration, and is not intended to be limiting. Aspects are implemented in further types of computer systems, as would be known to persons skilled in the relevant art(s).

As shown in FIG. 7, computing device 700 includes one or more processors, referred to as processor circuit 702, a system memory 704, and a bus 706 that couples various system components including system memory 704 to processor circuit 702. Processor circuit 702 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 702 is configured to execute program code stored in a computer readable medium, such as program code of operating system 730, application programs 732, other programs 734, etc. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules are stored on the hard disk, magnetic disk, optical disk, ROM, or RAM. These programs include operating system 730, one or more application programs 732, other programs 734, and program data 736. Application programs 732 or other programs 734 include, for example but without limitation, computer program logic (e.g., computer program code or instructions) for implementing the systems described above, including the aspects described above with reference to FIGS. 1-5.

A user is enabled to enter commands and information into the computing device 700 through input devices such as keyboard 738 and pointing device 740. Other input devices (not shown) include, but are not limited to in various aspects, a microphone, joystick, game pad, satellite dish, scanner, a touch screen and/or touch pad, a voice recognition system to receive voice input, a gesture recognition system to receive gesture input, or the like. These and other input devices are often connected to processor circuit 702 through a serial port interface 742 that is coupled to bus 706, but are enabled to be connected by other interfaces, such as a parallel port, game port, or a universal serial bus (USB).

A display screen 744 is also connected to bus 706 via an interface, such as a video adapter 746. Display screen 744, in aspects, is external to, or incorporated in, computing device 700. Display screen 744 is configured to display information, as well as being a user interface for receiving user commands and/or other information (e.g., by touch, finger gestures, a virtual keyboard, by providing a tap input (where a user lightly presses and quickly releases display screen 744), by providing a “touch-and-hold” input (where a user touches and holds his finger (or touch instrument) on display screen 744 for a predetermined period of time), by providing touch input that exceeds a predetermined pressure threshold, etc.). In addition to display screen 744, computing device 700 includes other peripheral output devices (not shown) such as speakers and printers.

Computing device 700 is connected to a network 748 (e.g., the Internet) through an adaptor or network interface 750, a modem 752, or other means for establishing communications over the network. Modem 752, which is internal or is external, is connected to bus 706 via serial port interface 742, as shown in FIG. 7, or is connected to bus 706 using another interface type, including a parallel interface, in various aspects.

As used herein, the terms “computer program medium,” “computer-readable medium,” “computer-readable storage medium,” and/or the like are used to generally refer to physical hardware media such as the hard disk associated with hard disk drive 714, removable magnetic disk 718, removable optical disk 722, other physical hardware media such as RAMs, ROMs, flash memory cards, digital video disks, zip disks, MEMs, nanotechnology-based storage devices, and further types of physical/tangible hardware storage media (including system memory 704 of FIG. 7). Such computer-readable media, computer-readable storage media, etc., are distinguished from and non-overlapping with communication media and propagating signals (do not include communication media and propagating signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Aspects are also directed to such communication media that are separate and non-overlapping with aspects directed to computer-readable storage media.

As noted above, computer programs and modules (including application programs 732 and other programs 734) is stored on the hard disk, magnetic disk, optical disk, ROM, RAM, or other hardware storage medium. Such computer programs are also received via network interface 750, serial port interface 752, or any other interface type. Such computer programs, when executed or loaded by an application, enable computing device 700 to implement features of aspects discussed herein. Accordingly, such computer programs represent controllers of the computing device 700.

Aspects are also directed to computer program products comprising computer code or instructions stored on any computer-readable medium. Such computer program products include hard disk drives, optical disk drives, memory device packages, portable memory sticks, memory cards, and other types of physical storage hardware.

### IV. Further Example Aspects

As described, systems and devices embodying the techniques herein are configured and enabled in various ways to perform their respective functions for platforms for information technology management as a service. In aspects, one or more of the steps or operations of any flowchart and/or flow diagram described herein are not to be performed. Moreover, steps or operations in addition to or in lieu of those in any flowchart and/or flow diagram described herein are performed. Further, in examples, one or more operations of any flowchart and/or flow diagram described herein are performed out of order, in an alternate sequence, or partially (or completely) concurrently with each other or with other operations.

As described herein, systems, devices, components, etc., of the aspects that are configured to perform functions and/or operations are also contemplated as performing such functions and/or operations.

Prior solutions fail to adequately address security issues with pre-authorized permissions in first-party applications for IT as a service applications that perform operations to alter computing environments and associated computing devices, and do not adequately provide for extensible implementations that are flexible enough to handle large numbers of computing environments and associated computing devices. Prior solutions instead focus on custom user/administrator accounts. In contrast, the aspects herein utilize an extensible platform for IT as a service applications with few or no pre-authorized permissions and Application-Only Authorization with application permissions that are computing environment-specific and only active for enrolled computing environments. Such aspects were previously not available for software-solutions in host provider architectures, much less for the specific aspects described herein for cloud-platforms, computing environments, and associated computing devices.

While aspects and aspects herein are described for simplicity and ease of illustrations in the context of cloud platforms and tenants thereof, other implementations are also contemplated such as ad hoc on-premise solutions and/or enterprise network solutions that do not expressly utilize tenancies, as would be understood by persons of skill in the relevant art(s) having the benefit of this disclosure. It should be understood that the aspects and aspects herein are extensible within cloud platform contexts in addition to on-premise and enterprise architectures.

The additional examples and aspects described in this Section are applicable to examples disclosed in any other Section or subsection of this disclosure.

Aspects in this description provide methods, systems, apparatuses, and computer-readable storage mediums that are configured for platforms for information technology management as a service.

For example, a computing system of a host provider is described. The computing system includes at least one memory that stores program code, and a processing system, comprising at least one processor, that receives the program code from the at least one memory and, in response to at least receiving the program code, to perform functions and operations. The functions and operations include to generate an instance of a servicing application in a computing environment for a client entity identifier, the servicing application having no pre-authorized permissions within the computing system; retrieve a certificate of the servicing application from a first data structure in a secure storage device of the computing system; receive an application authentication token, from an identity service associated with the computing system, based at least on the certificate; and perform an operation in the computing environment by the instance of the servicing application based at least on the application authentication token providing authorization for the instance of the servicing application.

In an aspect of the computing system, the processing system, in response to at least receiving the program code, associates, in a second data structure of the computing system, at least one minimal instance-specific permission with the instance of the servicing application that enable the servicing application to perform the operation in the computing environment.

In an aspect of the computing system, to generate the instance of the servicing application in the computing environment includes to generate a respective instance of the servicing application in at least one other of computing environments for different client entity identifiers.

In an aspect of the computing system, to generate a respective instance of the servicing application in at least one other of computing environments includes to execute a subset of the respective instance of the servicing application in the at least one other computing environments and validate an execution result thereof prior to respective instances outside of the subset being executed.

In an aspect of the computing system, the servicing application is deployed to the computing system with no pre-authorized permissions via a secure application portal that is inaccessible outside of a domain of a host provider identifier.

In an aspect of the computing system, the certificate is generated by the host provider identifier and written to the first data structure in the secure storage subsequent to the servicing application being deployed to the computing system; and the certificate is associated with the servicing application via the secure application portal.

In an aspect of the computing system, the operation includes at least one of altering of a configuration setting for at least one device associated with the computing environment; installing a software update associated with an instance of an application in the computing environment; creating or modifying a group in a directory for the computing environment; or altering an access policy for the computing environment.

A method, performed by a computing system of a host provider, is also provided. The method includes generating an instance of a servicing application in a computing environment for a client entity identifier, the servicing application having no pre-authorized permissions within the computing system; retrieving a certificate of the servicing application from a first data structure in a secure storage device of the computing system; receiving an application authentication token, from an identity service associated with the computing system, based at least on the certificate; and performing an operation in the computing environment by the instance of the servicing application based at least on the application authentication token providing authorization for the instance of the servicing application.

In an aspect, the method includes associating, in a second data structure of the computing system, at least one minimal instance-specific permission with the instance of the servicing application that enable the servicing application to perform the operation in the computing environment.

In an aspect of the method, generating the instance of the servicing application in the computing environment includes generating a respective instance of the servicing application in at least one other of computing environments for different client entity identifiers.

In an aspect of the method, generating a respective instance of the servicing application in at least one other of computing environments includes executing a subset of the respective instance of the servicing application in the at least one other computing environments and validating an execution result thereof prior to respective instances outside of the subset being executed.

In an aspect of the method, the servicing application is deployed to the computing system with no pre-authorized permissions via a secure application portal that is inaccessible outside of a domain of a host provider identifier.

In an aspect of the method, the certificate is generated by the host provider identifier and written to the first data structure in the secure storage subsequent to the servicing application being deployed to the computing system; and the certificate is associated with the servicing application via the secure application portal.

In an aspect of the method, the operation includes at least one of altering of a configuration setting for at least one device associated with the computing environment; installing a software update associated with an instance of an application in the computing environment; creating or modifying a group in a directory for the computing environment; or altering an access policy for the computing environment.

A computer-readable storage medium having program instructions recorded thereon that, when executed by at least one processor of a computing system of a host provider, perform a method is also provided. The method includes generating an instance of a servicing application in a computing environment for a client entity identifier, the servicing application having no pre-authorized permissions within the computing system; retrieving a certificate of the servicing application from a first data structure in a secure storage device of the computing system; receiving an application authentication token, from an identity service associated with the computing system, based at least on the certificate; and performing an operation in the computing environment by the instance of the servicing application based at least on the application authentication token providing authorization for the instance of the servicing application.

In an embodiment of the computer-readable storage medium, the method includes associating, in a second data structure of the computing system, at least one minimal instance-specific permission with the instance of the servicing application that enable the servicing application to perform the operation in the computing environment.

In an embodiment of the computer-readable storage medium, with respect to the method, generating the instance of the servicing application in the computing environment includes generating a respective instance of the servicing application in at least one other of computing environments for different client entity identifiers.

In an embodiment of the computer-readable storage medium, with respect to the method, generating a respective instance of the servicing application in at least one other of computing environments includes executing a subset of the respective instance of the servicing application in the at least one other computing environments and validating an execution result thereof prior to respective instances outside of the subset being executed.

In an embodiment of the computer-readable storage medium, the servicing application is deployed to the computing system with no pre-authorized permissions via a secure application portal that is inaccessible outside of a domain of a host provider identifier.

In an embodiment of the computer-readable storage medium, the certificate is generated by the host provider identifier and written to the first data structure in the secure storage subsequent to the servicing application being deployed to the computing system; and the certificate is associated with the servicing application via the secure application portal.

Another computing system of a host provider is also described. The computing system of the host provider includes at least one memory that stores program code, and a processing system, comprising at least one processor, configured to receive the program code from the at least one memory and, in response to at least receiving the program code, to perform functions and operations. The functions and operations include to generate an instance of a servicing application in a computing environment, for a client entity identifier, the servicing application having fewer pre-authorized permissions within the computing system than another application that has an instance thereof in the computing environment, retrieve a certificate of the servicing application from a first data structure in a secure storage device of the computing system, receive an application authentication token, from an identity service associated with the computing system, based at least on the certificate, and perform an operation in the computing environment by the instance of the servicing application based at least on the application authentication token providing authorization for the instance of the servicing application.

### V. Further Notes Regarding the Specification

References in this Specification to “one implementation,” “an implementation,” “an aspect,” “an example aspect,” “example implementation,” or the like, indicate that the implementation described are contemplated as including a particular feature, structure, or characteristic, but every implementation is not necessarily inclusive of the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the Specification, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

If the performance of an operation is described herein as being “based on” one or more factors, it is to be understood that the performance of the operation can be based solely on such factor(s) or can be based on such factor(s) along with one or more additional factors. Thus, as used herein, the term “based on” should be understood to be equivalent to the term “based at least on.” Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors.

### VI. Conclusion

While various example aspects have been described above, it should be understood that they have been presented by way of example only, and not limitation. It will be understood by those skilled in the relevant art(s) that various changes in form and details are made therein without departing from the spirit and scope of the aspects as defined in the appended claims. Accordingly, the breadth and scope of the disclosure should not be limited by any of the above-described example aspects, but should be defined only in accordance with the following claims and their equivalents.

What is claimed is:

1. A computing system of a host provider, comprising:
at least one memory that stores program code; and
a processing system, comprising at least one processor, that receives the program code from the at least one memory and, in response to at least receiving the program code, to:
generate an instance of a servicing application in a computing environment for a client entity identifier, the servicing application having no pre-authorized permissions within the computing system;
retrieve a certificate of the servicing application from a first data structure in a secure storage device of the computing system;
receive an application authentication token, from an identity service associated with the computing system, based at least on the certificate; and
perform an operation in the computing environment by the instance of the servicing application based at least on the application authentication token providing authorization for the instance of the servicing application.

2. The computing system of claim 1, wherein the processing system, in response to at least receiving the program code, associates, in a second data structure of the computing system, at least one minimal instance-specific permission with the instance of the servicing application that enable the servicing application to perform the operation in the computing environment.

3. The computing system of claim 1, wherein to generate the instance of the servicing application in the computing environment includes to generate a respective instance of the servicing application in at least one other of computing environments for different client entity identifiers.

4. The computing system of claim 3, wherein to generate a respective instance of the servicing application in at least one other of computing environments includes to execute a subset of the respective instance of the servicing application in the at least one other computing environments and validate an execution result thereof prior to respective instances outside of the subset being executed.

5. The computing system of claim 1, wherein the servicing application is deployed to the computing system with no pre-authorized permissions via a secure application portal that is inaccessible outside of a domain of a host provider identifier.

6. The computing system of claim 5, wherein the certificate is generated by the host provider identifier and written to the first data structure in the secure storage subsequent to the servicing application being deployed to the computing system; and
wherein the certificate is associated with the servicing application via the secure application portal.

7. The computing system of claim 1, wherein the operation includes at least one of:
altering of a configuration setting for at least one device associated with the computing environment;
installing a software update associated with an instance of an application in the computing environment;
creating or modifying a group in a directory for the computing environment; or
altering an access policy for the computing environment.

8. A method, performed by a computing system of a host provider, comprising:
generating an instance of a servicing application in a computing environment for a client entity identifier, the servicing application having no pre-authorized permissions within the computing system;
retrieving a certificate of the servicing application from a first data structure in a secure storage device of the computing system;
receiving an application authentication token, from an identity service associated with the computing system, based at least on the certificate; and
performing an operation in the computing environment by the instance of the servicing application based at least on the application authentication token providing authorization for the instance of the servicing application.

9. The method of claim 8, further comprising:
associating, in a second data structure of the computing system, at least one minimal instance-specific permission with the instance of the servicing application that enable the servicing application to perform the operation in the computing environment.

10. The method of claim 8, wherein generating the instance of the servicing application in the computing environment includes generating a respective instance of the servicing application in at least one other of computing environments for different client entity identifiers.

11. The method of claim 10, wherein generating a respective instance of the servicing application in at least one other of computing environments includes executing a subset of the respective instance of the servicing application in the at least one other computing environments and validating an execution result thereof prior to respective instances outside of the subset being executed.

12. The method of claim 8, wherein the servicing application is deployed to the computing system with no pre-authorized permissions via a secure application portal that is inaccessible outside of a domain of a host provider identifier.

13. The method of claim 12, wherein the certificate is generated by the host provider identifier and written to the first data structure in the secure storage subsequent to the servicing application being deployed to the computing system; and
wherein the certificate is associated with the servicing application via the secure application portal.

14. The method of claim 8, wherein the operation includes at least one of altering of a configuration setting for at least one device associated with the computing environment;
installing a software update associated with an instance of an application in the computing environment;
creating or modifying a group in a directory for the computing environment; or
altering an access policy for the computing environment.

15. A computer-readable storage medium having program instructions recorded thereon that, when executed by at least one processor of a computing system of a host provider, perform a method comprising:
generating an instance of a servicing application in a computing environment for a client entity identifier, the servicing application having no pre-authorized permissions within the computing system;
retrieving a certificate of the servicing application from a first data structure in a secure storage device of the computing system;
receiving an application authentication token, from an identity service associated with the computing system, based at least on the certificate; and
performing an operation in the computing environment by the instance of the servicing application based at least on the application authentication token providing authorization for the instance of the servicing application.

16. The computer-readable storage medium of claim 15, wherein the method further comprises:
associating, in a second data structure of the computing system, at least one minimal instance-specific permission with the instance of the servicing application that enable the servicing application to perform the operation in the computing environment.

17. The computer-readable storage medium of claim 15, wherein generating the instance of the servicing application in the computing environment includes generating a respective instance of the servicing application in at least one other of computing environments for different client entity identifiers.

18. The computer-readable storage medium of claim 17, wherein generating a respective instance of the servicing application in at least one other of computing environments includes executing a subset of the respective instance of the servicing application in the at least one other computing environments and validating an execution result thereof prior to respective instances outside of the subset being executed.

19. The computer-readable storage medium of claim 15, wherein the servicing application is deployed to the computing system with no pre-authorized permissions via a secure application portal that is inaccessible outside of a domain of a host provider identifier.

20. The computer-readable storage medium of claim 19, wherein the certificate is generated by the host provider identifier and written to the first data structure in the secure storage subsequent to the servicing application being deployed to the computing system; and
wherein the certificate is associated with the servicing application via the secure application portal.
